(19) United States
(12) Patent Application Publication
(10) Pub. No.: US 2024/0118152 A1
(43) Pub. Date: Apr. 11, 2024

(54) ARITHMETIC LOGIC UNIT, EQUIPMENT MANAGEMENT METHOD, AND PROGRAM

(71) Applicant: NIPPON TELEGRAPH AND TELEPHONE CORPORATION, Tokyo (JP)

(72) Inventors: Gen KOBAYASHI, Musashino-shi, Tokyo (JP); Kazuya ANDO, Musashino-shi, Tokyo (JP); Masaki WAKI, Musashino-shi, Tokyo (JP); Ryoichi KANEKO, Musashino-shi, Tokyo (JP); Hiroaki TANIOKA, Musashino-shi, Tokyo (JP)

(73) Assignee: NIPPON TELEGRAPH AND TELEPHONE CORPORATION, Tokyo (JP)

(21) Appl. No.: 17/768,187

(22) PCT Filed: Oct. 23, 2019
(86) PCT No.: PCT/JP2019/041516

§ 371 Date: Apr. 11, 2022

(51) Int. Cl. G01L 5/04; H02G 1/02

(52) U.S. Cl. CPC G01L 5/04; H02G 1/02

(57) ABSTRACT

The present invention has an object of providing an arithmetic apparatus, a facility management method, and a program that make it possible to acquire current tension applied to outdoor structures in a short period of time and make a bearing determination. The arithmetic apparatus according to the present invention calculates the dip degree of a cable and a distance between poles from the 3D model data of the cable according to Math. C1 and calculates the tension of each cable between the poles from the dip degree, the distance between the poles, and the weight of the cable per unit length according to Math. C2 (when no wind blows) or Math. C4 (when wind blows). Further, the arithmetic apparatus according to the present invention calculates a combined load obtained by converting the tension and the load of the accessory of the poles into an arbitrary position on the poles according to Math. C3.

### TECHNICAL FIELD

The present disclosure relates to an arithmetic apparatus, a calculation method, and a program for calculating the tension and the combined load of a cable hung on outdoor structures such as electric poles.

### BACKGROUND ART

FIG. 1 is a view for explaining an example of a facility including outdoor structures (poles) and cables. When there is any change in the mode of the facility such as removing a branch line due to a private land, an obstacle, and any other reason after the construction of the facility as shown in FIG. 1, an unbalanced load is generated in the poles. When the unbalanced load is generated in the poles, the poles are inclined or deflected. Cable distances between the poles and dip degrees are changed as the poles are inclined or deflected. As a result, tension applied to the poles is changed. Therefore, current tension is likely to be different from that applied at installation.

FIG. 2 is a view for explaining a management method for an outdoor structure. When a comparison between tension and the design strength of a pole (design strength), that is, a bearing determination is made, tension or the like at the respective strung points of the pole is converted into a combined load applied to a reference point (a load application point) by moment calculation as shown in FIG. 2. However, as described above, tension applied to the pole becomes different from that applied at installation when an unbalanced load is generated in the pole. As a result, a current combined load applied to a load application point is deviated from that applied at installation.

Therefore, when there is any change in the mode of a facility or on a regular basis, an operator is required to go to an actual spot, measure a cable distance between poles or a dip degree by visual observation or by hand, and calculate current tension.

### CITATION LIST

### Patent Literature

[PTL 1] Japanese Patent Application Laid-open No. 2018-195240

### Non Patent Literature

[NPL 1] “Haiden kitei (teiatsu oyobi kouatsu) (Power Distribution Code (Low Voltage and High Voltage))”, JEAC7001-2017

### SUMMARY OF THE INVENTION

### Technical Problem

The present invention solves the following three problems.

### (Problem 1) Current Tension Applied to Poles is Uncertain

As described above, poles are inclined or deflected when an unbalanced load is generated in the poles. Therefore, a cable distance between the poles and a dip degree are changed. As a result, tension applied to the poles is changed, and actual tension becomes different from that applied at installation.

(Problem 2) the Conversion of Tension Applied to Poles into Load Application Point is Inaccurate

When a bearing determination is made with respect to the design strength of poles, tension at the respective strung points of the poles is required. However, as described above, tension applied to the poles is changed when an unbalanced load is generated in the poles. As a result, actual tension becomes different from that applied at installation. Further, in order to make a bearing determination in consideration of deformation such as the inclination and the deflection of the poles, the conversion of tension into an arbitrary load application point is required.

### (Problem 3) Enormous Time is Required to Perform Measurement by Operator

Currently, since an operator measures a cable distance between poles and a dip degree by visual observation or by hand to calculate actual tension, an enormous time is required.

Therefore, in order to solve the above problems, the present invention has an object of providing an arithmetic apparatus, a facility management method, and a program that make it possible to acquire current tension applied to outdoor structures in a short period of time and make a bearing determination.

### Means for Solving the Problem

In order to achieve the above object, an arithmetic apparatus according to the present invention calculates the dip degree of a cable and a distance between poles from the 3D model data of the cable according to Math. C1 and calculates the tension of each cable between the poles from the dip degree, the distance between the poles, and the weight of the cable per unit length according to Math. C2 (when no wind blows) or Math. C3 (when wind blows). Further, the arithmetic apparatus according to the present invention calculates a combined load obtained by converting the tension and the load of the accessory of the poles into an arbitrary position on the poles according to Math. C3.

Specifically, an arithmetic apparatus according to the present invention includes:
an input unit to which point cloud data of outdoor structures to be managed and a cable hung on the outdoor structures is input;
a coordinate acquisition unit that acquires coordinate (p, q, r) of a lowest point of the cable and coordinates (a, b, c) and (x, y, z) of strung points at which the cable is hung on the two outdoor structures from the point cloud data; and
an arithmetic unit that
calculates a distance S (m) between the outdoor structures and a dip degree d₀ (m) of the cable accordingto Math. C1,
substitutes a load W₀ (N/m) of the cable per unit length obtained from a database, the distance S, and the dip degree d₀ into Math. C2 to calculate tension T₀ (N) of the cable applied to the outdoor structures,
multiplies the tension T₀ (N) by heights Hᵢ (m) of the strung points to calculate moment (N·m) at the strung points, and
divides the moment by one arbitrary height H (m) of the outdoor structures to calculate a load T′ (N)

$$\begin{matrix}[ Math . C1 ] & \\ S = \sqrt{{( x - a )}^{2} + {( y - b )}^{2}} \\ {d}_{0} = \frac{\frac{z - c}{2} + ( c - r ) + \sqrt{{( c - r )}^{2} + ( c - r ) ( z - c )}}{2} & ( C1 )\end{matrix}$$

$$\begin{matrix}[ Math . C2 ] & \\ {T}_{0} = \frac{{W}_{0} {S}^{2}}{8 {d}_{0}} & ( C2 )\end{matrix}$$

A facility management method according to the present invention includes:
acquiring point cloud data of outdoor structures to be managed and a cable hung on the outdoor structures;
acquiring coordinate (p, q, r) of a lowest point of the cable and coordinates (a, b, c) and (x, y, z) of strung points at which the cable is hung on the two outdoor structures from the point cloud data;
calculating a distance S (m) between the outdoor structures and a dip degree d₀ (i) of the cable according to Math. C1;
substituting a load W₀ (N/n) of the cable per unit length obtained from a database, the distance S, and the dip degree d₀ into Math. C2 to calculate tension T₀ (N) of the cable applied to the outdoor structures;
multiplying the tension T₀ (N) by heights Hᵢ (m) of the strung points to calculate moment (N·m) at the strung points; and
dividing the moment by one arbitrary height H (m) of the outdoor structures to be converted into a load T′ (N).

First, the arithmetic apparatus and the facility management method according to the present invention can use a laser scanner or the like to perform the three-dimensional measurement of a cable distance between poles and a dip degree since the use of the 3D model data of the cable is allowed. Therefore, an operator is not required to measure a cable distance between poles and a dip degree by hand. Accordingly, the arithmetic apparatus and the facility management method according to the present invention can solve the problem 3.

Further, as shown in FIG. 3, the arithmetic apparatus and the facility management method according to the present invention can calculate tension (T_{α}, T_{β}) at respective strung points using cable distances between poles and dip degrees in consideration of deformation such as the inclination and the deflection of the poles and a change in the dip degrees. That is, the arithmetic apparatus and the facility management method according to the present invention can calculate current tension (T_{α}, T_{β}) from results obtained by measuring the current shapes of poles and cables with a laser scanner or the like. Accordingly, the arithmetic apparatus and the facility management method according to the present invention can solve the problem 1.

In addition, as shown in FIG. 4, the arithmetic apparatus and the facility management method according to the present invention can convert tension at respective strung points calculated by the above method into a load application point at an arbitrary position. Accordingly, the arithmetic apparatus and the facility management method according to the present invention can solve the problem 2.

As described above, the present invention can provide the arithmetic apparatus and the facility management method that make it possible to acquire current tension applied to outdoor structures in a short period of time and make a bearing determination.

Note that when a plurality of the cables exist, the arithmetic unit
calculates the moment (N·m) for each of the cables,
vector-adds the moment (N·m) for each of the cables to calculate combined moment, and
divides the combined moment by the arbitrary height H (m) to calculate a combined load T′ (N).

Further, when the outdoor structures are accompanied with an accessory having a weight of Z (N),
the arithmetic unit
multiplies the weight Z (N) by a horizontal distance L (m) between a strung point at which the accessory is attached to the outdoor structure and a center of gravity of the accessory to calculate moment (N·m) at the strung point of the accessory,
vector-adds (N·m) of the cable and the accessory to calculate combined moment, and
divides the combined moment by the arbitrary height H (m) to calculate a combined load T′ (N).

Further, the arithmetic apparatus and the facility management method according to the present invention can perform a series of the calculation with the setting of an arbitrary wind speed.

The cable is constituted by one or a plurality of cables, a support body hung on the strung points of the outdoor structures, and a bundling hanger with which the cables are hung on the support body, and
tension T₁ (N) calculated from Math. C3 is regarded as the tension T₀ (N) when wind blows during acquisition of the point cloud data.

$$\begin{matrix}[ Math . C3 ] & \\ {T}_{1}^{3} + EA \{ α ( {θ}_{1} - {θ}_{0} ) + \frac{1}{24} {( \frac{{W}_{0} S}{{T}_{0}} )}^{2} - \frac{{T}_{0}}{EA} \} {T}_{1}^{2} - \frac{1}{24} {EA ( {W}_{1} S )}^{2} = 0 & ( C3 )\end{matrix}$$

where
θ₀ (° C.) represents a temperature when no wind blows, θ₁ (° C.) represents a temperature when wind blows, E (N/m²) represents a Young's modulus of the support body, A (m²) represents a cross-sectional area of the support body, α (1/° C.) represents a linear expansion coefficient of the support body, W₁ (N/m)=√(W₀²+W_{c}²) represents a cable load per unit length when wind blows, and W_{c} (N/m) represents a wind pressure load per unit length generated in the cable due to wind. The wind pressure load W_{c} (N/m) is calculated by Math. C4 using a coefficient K (N/m²) according to a wind pressure load type, an outer diameter D (m) of the bundling hanger, and a total L (m) of the outer diameters of the cables supported by the bundling hanger and a cross-sectional height of the bundling hanger.

$$\begin{matrix}[ Math . C4 ] & \\ When a sum of the outer diameters of the cables is less than & \end{matrix}$$

$$or equal to the outer diameter D ( m ) of the bundling hanger$$

$$We = K \times L$$

$$When a sum of the outer diameters of the cables is greater than$$

$$or equal to the outer diameter D ( m ) of the bundling hanger$$

$$We = K \times D$$

The arithmetic apparatus according to the present invention can be realized by a computer and a program as well, and the program can be recorded on a recording medium or provided via a network. That is, the present invention is a program causing a computer to function as the arithmetic apparatus.

Note that the above respective inventions can be combined together to a greater extent.

### Effects of the Invention

The present invention can provide an arithmetic apparatus, a facility management method, and a program that make it possible to acquire current tension applied to outdoor structures in a short period of time and make a bearing determination.

That is, by solving the problem 1 with the present invention and calculating tension in consideration of the actual deformation of poles and a change in a dip degree, tension at respective strung points can be calculated more accurately than a conventional, method.

Further, by solving the problem 2 with the present invention, conversion into a load application point can be performed in consideration of the actual deformation of poles, and a bearing determination with respect to the design strength of the poles can be more accurately performed than a conventional method. Further, a combined load is calculated with the setting of an arbitrary wind speed, whereby it is possible to make a bearing determination with respect to the design strength of poles under an unexpected natural environment such as a recent large typhoon for each electric pole. Therefore, the ranking of electric poles to be renewed can be performed.

In addition, by solving the problem 3 with present invention, three-dimensional measurement can be accurately and comprehensively performed, and the number of man hours by an operator can be reduced.

### BRIEF DESCRIPTION OF DRAWINGS

FIG. 1 is a view for explaining an example of a facility including outdoor structures (poles) and cables.

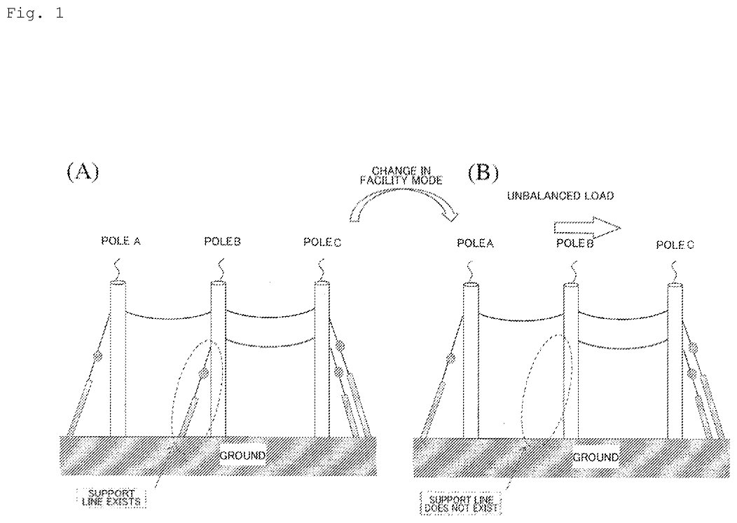

FIG. 2 is a view for explaining a management method for an outdoor structure.

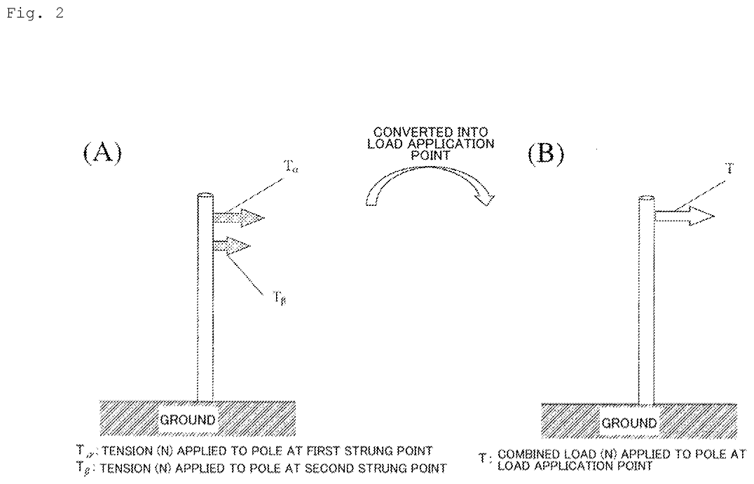

FIG. 3 is a view for explaining a method for calculating tension by an arithmetic apparatus according to the present invention.

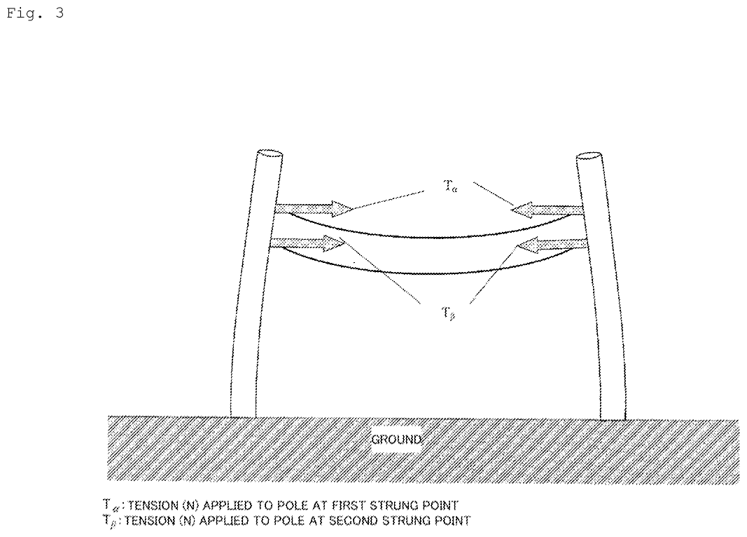

FIG. 4 is a view for explaining a method for calculating tension by the arithmetic apparatus according to the present invention.

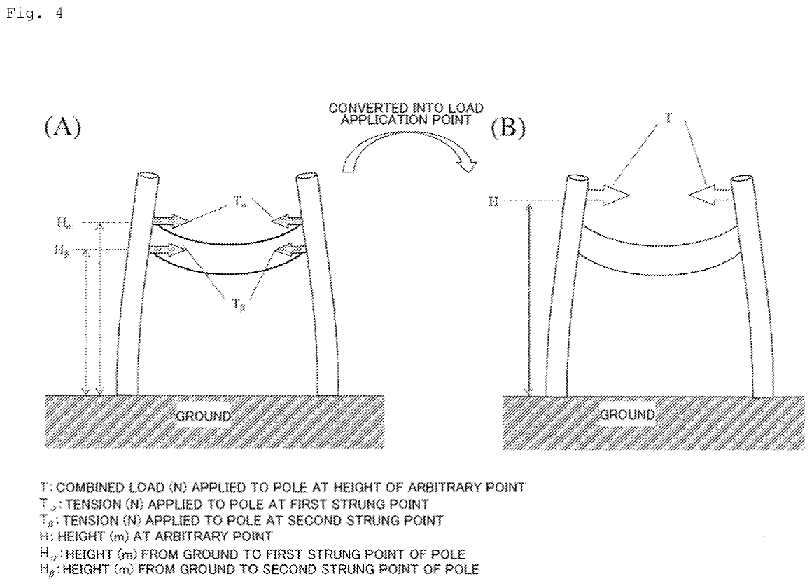

FIG. 5 is a diagram for explaining the arithmetic apparatus according to the present embodiment.

FIG. 6 is a view for explaining a MMS and a stationary type laser scanner.

FIG. 7 is a view for explaining an example of 3D model data.

FIG. 8 is a view for explaining a method for acquiring coordinates from 3D model data.

FIG. 9 is a view for explaining a method for converting tension at a strung point into a load at an arbitrary height.

FIG. 10 is a view for explaining a method for calculating tension by the arithmetic apparatus according to the present invention.

FIG. 11 is a flowchart for explaining a facility management method according to the present embodiment.

FIG. 12 is a flowchart for explaining a method for performing the 3D modeling of a cable or a facility in the facility management method according to the present invention.

FIG. 13 is a view for explaining a method (when wind blows) for calculating tension by the arithmetic apparatus according to the present embodiment, wherein (A) is a general view, and (B) is a view for explaining a load at the lowest point G.

FIG. 14 is a block diagram for explaining the arithmetic apparatus according to the present invention.

FIG. 15 is a view for explaining the proof of a formula.

FIG. 16 is a view for explaining the relationship between coordinates and a distance.

FIG. 17 is a view for explaining a load generated in cables by wind.

FIG. 18 is a view for explaining the cross section of a bundling hanger.

FIG. 19 is a view for explaining the support body of a cable.

### DESCRIPTION OF EMBODIMENTS

Embodiments of the present invention will be described with reference to the accompanying drawings. The following embodiments are examples of the present invention, and the present invention is not limited to the following embodiments. Note that constituting elements having the same symbols in the present specification and the drawings show the same elements.

### First Embodiment

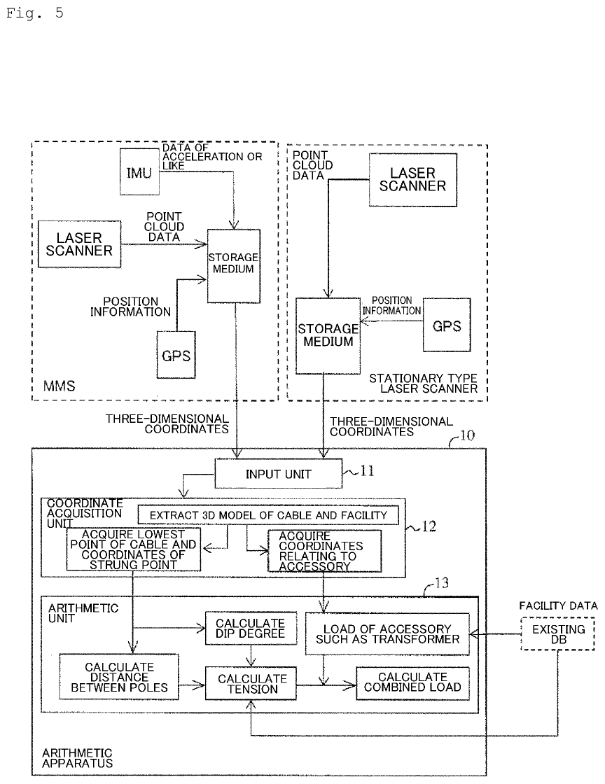

FIG. 5 is a diagram for explaining an arithmetic apparatus 10 according to the present embodiment. The arithmetic apparatus 10 includes:
an input unit to which point cloud data of outdoor structures to be managed and a cable hung on the outdoor structures is input;
a coordinate acquisition unit 12 that acquires coordinate (p, q, r) of the lowest point of the cable and coordinates (a, b, c) and (x, y, z) of strung points at which the cable is hung on the two outdoor structures from the point cloud data; and
an arithmetic unit 13 that
calculates a distance S (m) between the outdoor structures and a dip degree d₀ (m) of the cable according to Math. C1,
substitutes a load W₀ (N/m) of the cable per unit length obtained from a database, the distance S, and the dip degree d₀ into Math. C2 to calculate tension T₀ (N) of the cable applied to the outdoor structures,
multiplies the tension T₀ (N) by heights Hᵢ (m) of the strung points to calculate moment (N·m) at the strung points, and
divides the moment by one arbitrary height H (m) of the outdoor structures to be converted into a load T′ (N).

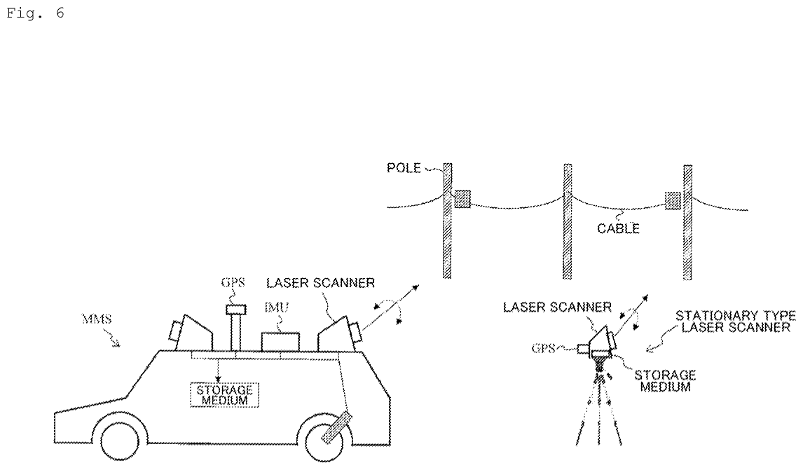

In FIG. 5, a mobile mapping system (hereinafter called a MMS) and a stationary type laser scanner that acquire the above point cloud data are also described. The MMS is an apparatus that has a three-dimensional laser scanner (3D laser measurement machine), a camera, a GPS (Global Positioning System), and an IMU (Inertial Measurement Unit) mounted in a vehicle, comprehensively performs the three-dimensional measurement of outdoor structures including surrounding poles, buildings, roads, bridges, steel towers, or the like while traveling on the road, and can collect the three-dimensional coordinates of a multiplicity of points on the surfaces of the outdoor structures. The stationary type laser scanner is an apparatus that has a 3D laser measurement machine and a GPS mounted therein, comprehensively performs the three-dimensional measurement of surrounding outdoor structures at an installed place, and can collect the three-dimensional coordinates of a multiplicity of points on the surfaces of the outdoor structures (see FIG. 6).

First, the data of three-dimensional distances to outdoor structures, the position coordinates of the vehicle, and the acceleration data of the vehicle are acquired from the three-dimensional laser scanner, the GPS, and the IMU in the MMS, respectively, and input to a storage medium. Similarly, the data of three-dimensional distances to the outdoor structures are acquired from the three-dimensional laser scanner and the GPS in the stationary type laser scanner, respectively, and input to a storage medium.

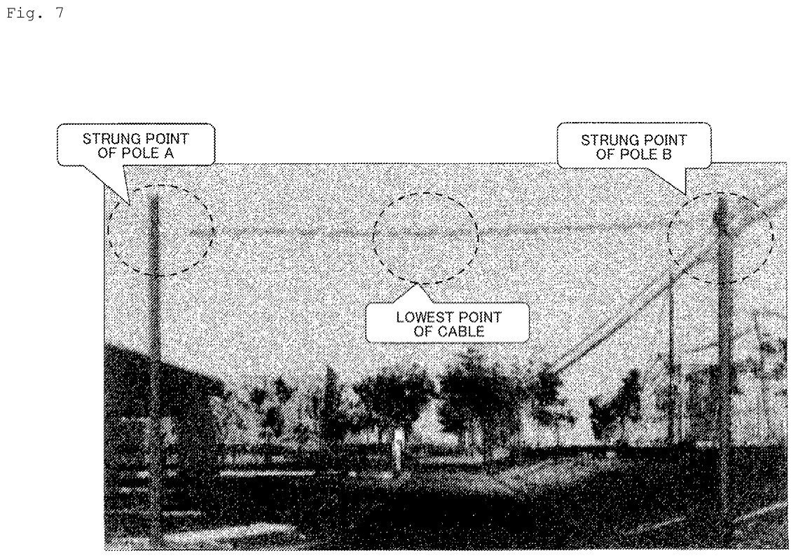

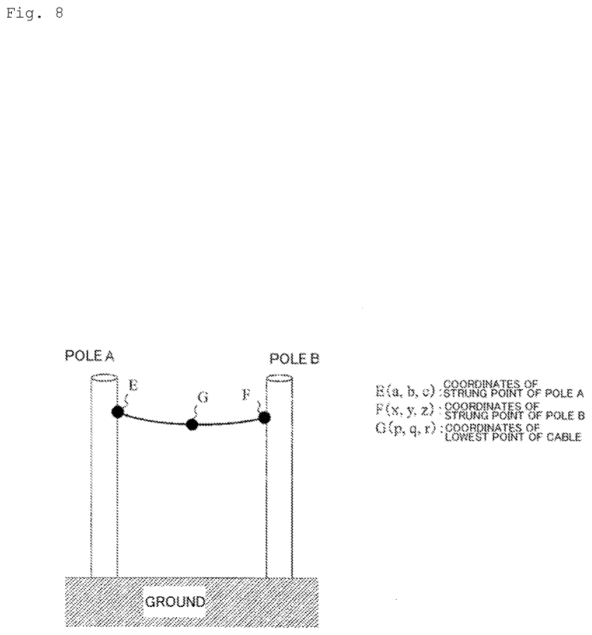

The point cloud data stored in the storage media is input to the input unit 11 of the arithmetic apparatus 10 and subjected to the generation of the three-dimensional modeling (hereinafter called 3D model data) of a cable and other facilities by the extraction processing unit of the coordinate acquisition unit 12. FIG. 7 is a view for explaining an example of the 3D model data. The coordinate acquisition unit 12 acquires the coordinate (p, q, r) of the lowest point G of a cable and the coordinates (a, b, c) and (x, y, z) of strung points E and F of two poles from the 3D model data (FIG. 8). These coordinates are acquirable by a technology described in PTL 1 or the like.

According to Math. C1, the arithmetic unit 13 calculates a distance S between the poles and a dip degree d₀ from the coordinate (p, q, r) of the lowest point G and the coordinates (a, b, c) and (z, y, z) of the strung points E and F. Note that the derivation of Math. C1 will be described in Appendix 1.

In addition, the arithmetic unit 13 acquires a weight W₀ per cable length from facility data and substitutes the acquired weight W₀ into Math. C2 together with the distance C between the poles and the dip degree d₀ calculated beforehand to calculate tension T₀. Math. C2 is a tension formula described in NPL 1 (p. 204). Note that the tension T₀ applied to the poles is expressed as (N), the cable load W₀ per unit length is expressed as (N/m), the distance S between the poles is expressed as (m), and the dip degree d₀ is expressed as (m) as the units of respective parameters.

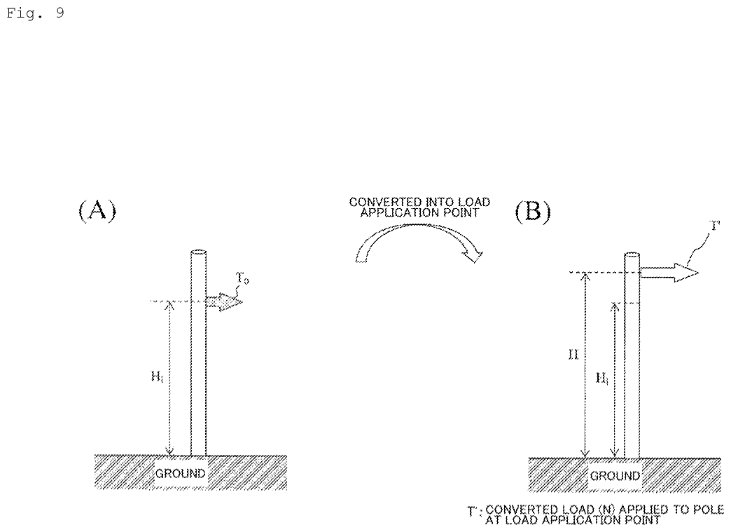

Here, when tension T₀ at a strung point (height Hᵢ) is converted into a load T′ (N) at an arbitrary point (height H) of a pole as shown in FIG. 9, the following value is obtained.

T′=T₀×Hᵢ/H

Note that when a plurality of cables are hung on poles, the arithmetic unit 13 calculates moment at a strung point for each of the cables from each tension and combines the calculated moment together. Then, by dividing the combined moment by an arbitrary height H (m) and adding up the resultants, the arithmetic unit 13 can calculate a combined load T′ (N). Note that the arithmetic unit 13 vector-adds the moment when each tension is oriented in a different direction.

Further, when outdoor structures are accompanied with an accessory (for example, a transformer) having a weight of Z (N), the arithmetic unit 13 multiplies the weight Z (N) by a horizontal distance L (m) between a strung point at which the accessory is attached to the outdoor structure and the center of gravity of the accessory to calculate moment (N·m) at the strung point of the accessory,
vector-adds the moment (N·m) of the cable and the accessory to calculate combined moment, and
divides the combined moment by the arbitrary height H (m) to calculate a combined load T′ (N).

That is, when the weight of an accessory is converted into a load Tz (N) at an arbitrary point (height H) of a pole, the following value is obtained.

Tz=Z×L/H

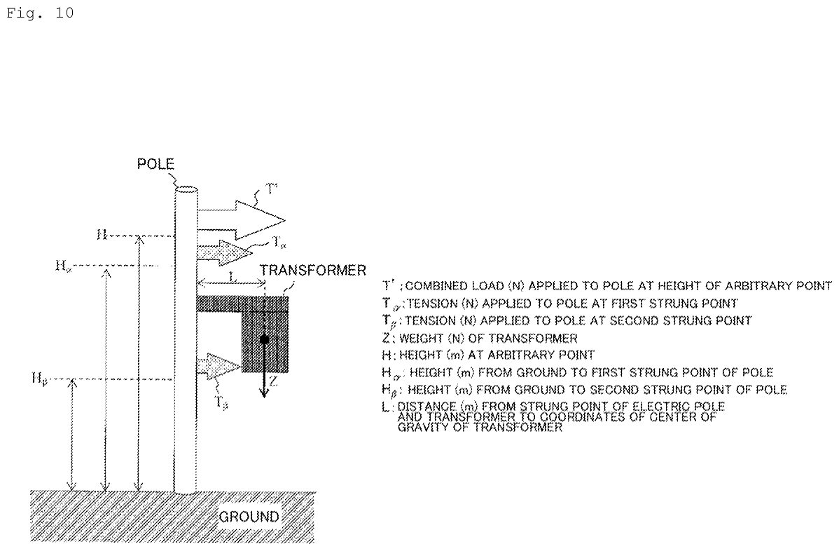

A specific description will be given with reference to FIG. 10. It is assumed that two cables are hung on a pole and one transformer is attached to the pole. In such a case, the arithmetic unit 13 calculates a combined load T′ (N) applied to the pole at the height of an arbitrary point according to the following formula.

$$\begin{matrix}[ Math . 1 ] & \\ {T}^{′} = \frac{{H}_{α}}{H} {T}_{α} + \frac{{H}_{β}}{H} {T}_{β} + \frac{L}{H} Z & ( 1 )\end{matrix}$$

Here, T_{α} (N) represents a first strung point, T_{β} (N) represents tension applied to the pole at a second strung point, Z (N) represents the weight of the transformer, H (m) represents the height of an arbitrary point, H_{α} (m) represents a height from the around to the first strung point of the pole, H_{β} (m) represents a height from the ground to the second strung point of the pole, and L (m) represents a distance from the strung point of the electric pole and the transformer to the coordinates of the center of gravity of the transformer.

According to the moment calculation of Math. 1, the arithmetic unit 13 can calculate a combined load obtained by converting tension applied to respective strung points or the load of an accessory such as a transformer into an arbitrary point of a pole. Note that when the directions of tension T_{α} and T_{β} are different from the installation direction of a transformer, it is only required to express respective moment as vectors and calculate combined moment by vector calculation.

### [Supplemental Remarks]

### *Moment of Respective Strung Points:

When it is assumed that the ground is a supporting point and strung points are application points, moment applied to the respective strung points is expressed by the product of tension and distances from the supporting point to the application points.

### *Moment of Transformer:

The moment of a transformer is expressed by the product of the weight of the transformer and a distance from the strung point of an electric pole and the transformer to the coordinates of the center of gravity of the transformer.

*Combined load at arbitrary point:

A combined load at an arbitrary point is calculated by dividing the combined moment of respective moment calculated above by a distance from the ground to a point that is required to be calculated.

### Second Embodiment

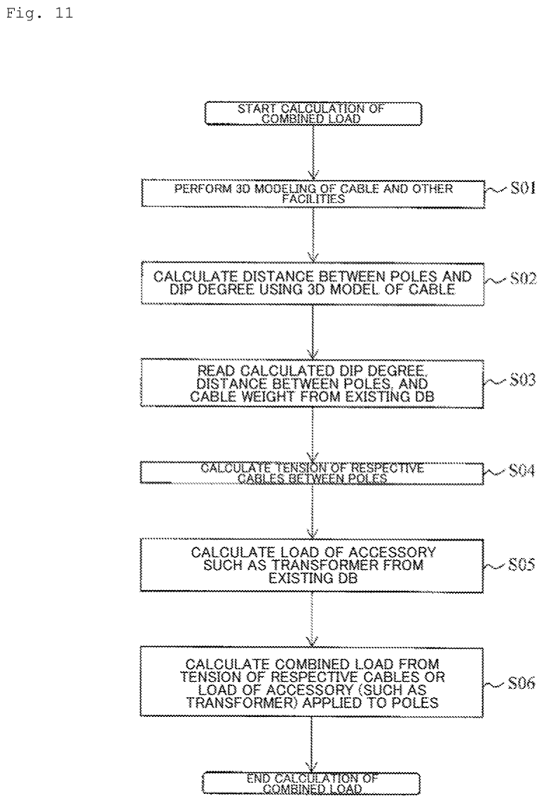

FIG. 11 is a flowchart for explaining a facility management method according to the present embodiment. The present facility management method includes:
acquiring point cloud data of outdoor structures to be managed and a cable hung on the outdoor structures;
acquiring coordinate (p, q, r) of the lowest point of the cable and coordinates (a, b, c) and (x, y, z) of strung points at which the cable is hung on the two outdoor structures from the point cloud data (step S01);
calculating a distance S (m) between the outdoor structures and a dip degree d₀ (m) of the cable according to Math. C1 (step S02);
substituting a load W₀ (N/m) of the cable per unit length obtained from a database, the distance S, and the dip degree d₀ into Math. C2 to calculate tension T₀ (N) of the cable applied to the outdoor structures (steps S03 and S04);
multiplying the tension T₀ (N) by heights Hᵢ (m) of the strung points to calculate moment (N·m) at the strung points; and
dividing the moment by one arbitrary height H (m) of the outdoor structures to calculate a load T′ (N) (step S06).

A detailed description will be given below.

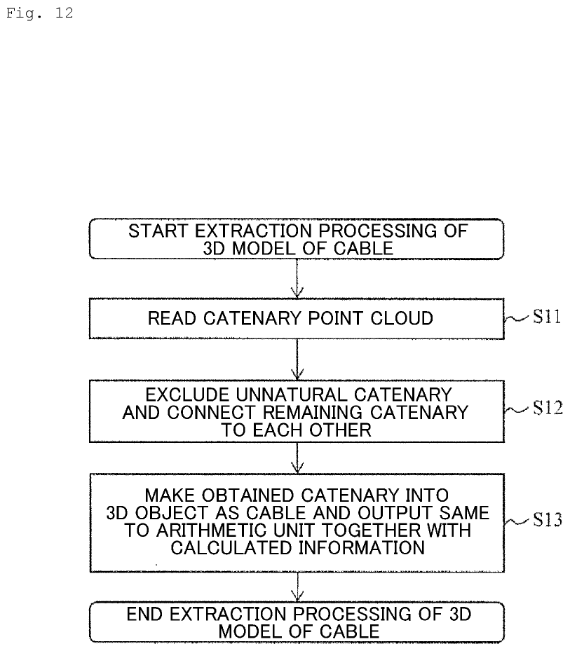

In step S01, the coordinate acquisition unit 12 comprehensively performs the three-dimensional measurement of outdoor structures including poles, buildings, roads, bridges, steel towers, or the like using a laser scanner or the like and performs the 3D modeling of a cable and other facilities from acquired three-dimensional coordinates. FIG. 12 is a flowchart for explaining processing to extract the 3D model of a cable in step S01. The coordinate acquisition unit 12 reads a catenary point cloud detected by the laser scanner (step S11). Then, the coordinate acquisition unit 12 excludes unnatural catenaries from the point cloud and connects remaining catenaries to each other (step S12). The coordinate acquisition unit 12 makes an obtained catenary into a 3D object as a cable (step S13).

In step S02, the coordinate acquisition unit 12 substitutes strung points and the three-dimensional coordinates of the lowest point shown in FIG. 8 into Math. C1 to calculate a distance S between poles and a dip degree d using the 3D model of the cable.

In step S03, the arithmetic unit 13 acquires a cable load W₀(N/m) per unit length. The cable load W₀ may be given from an external database, or may be input by an operator during calculation.

In step S04, the arithmetic unit 13 calculates tension applied to the electric poles by the dip degree of the cable at the respective strung points for each cable. When consideration is not given to wind, tension T₀ (N) applied to the electric poles by the dip degree at the respective strung points of the cable connected to the poles is calculated by substituting the values calculated in step S02 and the cable load W₀ (N/m) acquired in step S03 into Math. C2. On the other hand, when consideration is given to wind and a temperature, the arithmetic unit 13 calculates horizontal tension T₁ according to Math. C3 and Math. C4 that will be described later.

Step S05 is performed when an accessory such as a transformer other than the cable is attached to the poles. The arithmetic unit 13 acquires a weight Z of the accessory from a database or the like and calculates a load from a distance L (m) from the strung point of the poles and the accessory to the coordinates of the center of gravity of the accessory.

In step S06, the arithmetic unit 13 calculates a combined load T′ obtained by converting tension at the respective strung points or the weight of the accessory into an arbitrary point of the poles as shown in FIG. 10 according to Math. 1.

### Third Embodiment

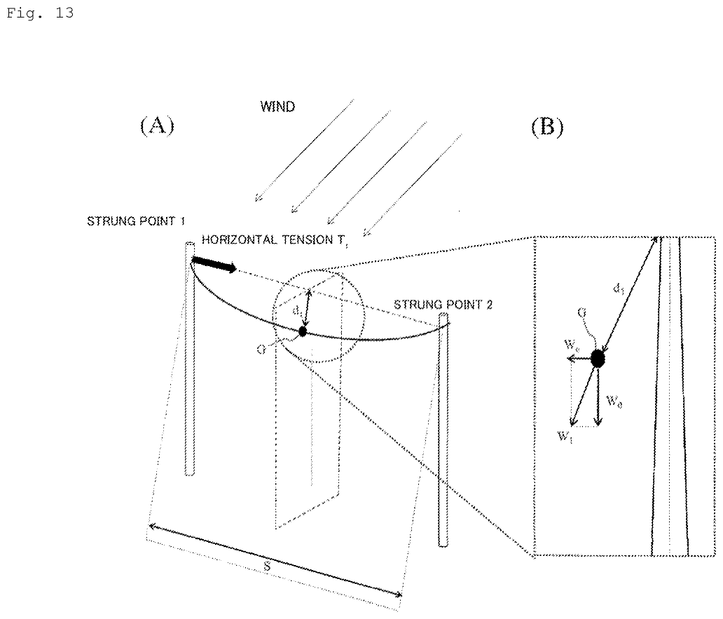

The present embodiment will describe a method for calculating tension when wind blows. FIG. 13 is a view for explaining a method for calculating tension according to the present embodiment. The configuration of an arithmetic apparatus is the same as that of FIG. 5. When consideration is given to wind, the mode of a cable is also required to be considered. The mode of a cable will be described in Appendix 2.

That is, when the cable is constituted by one or a plurality of cables, a support body hung on the strung points of the outdoor structures, and a bundling hanger with which the cables are hung on the support body and when wind blows during the acquisition of the point cloud data, the arithmetic unit 13 regards tension T₁(N) calculated according to Math. C3 as the tension T₀ (N) That is, the tension T₁ calculated according to Math. C3 is substituted into Math. 1 or the like as the tension T₀ to calculate a combined load T′.

A specific description will be given below.

When wind blows as shown in FIG. 13, stress is generated in poles themselves by the wind and tension applied to the poles by the cable is also generated. The arithmetic unit 13 calculates a load generated in the cable by wind as follows.

When the sum of the outer diameters of cables is less than or equal to an outer diameter D (m) of a bundling hanger, a horizontal load W_{c} (N/m) per unit length generated in the cables by wind can be calculated as Wc=K×L.

On the other hand, when the sum of the outer diameters of the cables is greater than the outer diameter D (m) of the bundling hanger, the horizontal load W_{c} (N/m) per unit length generated in the cables by wind can be calculated as Wc=K×D.

Here, K (N/m²) represents a coefficient according to a wind pressure load type, D (m) represents the outer diameter of the bundling hanger, and L (m) represents the total of the outer diameters of the cables inside the bundling hanger and the cross-sectional height of the bundling hanger.

A cable load W₁ (N/m) per unit length generated by wind is the vector sum of a cable load W₀ (N/m) and a horizontal load W_{c} (N/m) per unit length and therefore expressed by the following formula.

[Math. 2]

W₁=\sqrt{W₀²+W_{c}²} (2)

When wind blows, it is required to vector-convert the direction of wind blowing to the poles and the cable in three axial directions on the basis of the poles and the cable to convert a load by wind pressure. Further, when a temperature changes, horizontal tension changes with the expansion and the contraction of the cable. On this occasion, horizontal tension T₁ is calculated according to Math. C3 (see Appendix 3).

Note that in Math. C3, T₁ (N) represents horizontal tension when wind blows, θ₀ (° C.) represents a temperature when no wind blows, θ₁ (° C.) represents a temperature when wind blows, E (N/m²) represents a Young's modulus of a support body, A (m²) represents the cross-sectional area of the support body, and α (1/° C.) represents the linear expansion coefficient of the support body (see Appendix 4).

### Fourth Embodiment

The arithmetic apparatus 10 described in the first to third embodiments can be realized by a computer and a program as well. The program can be recorded on a recording medium or provided via a network.

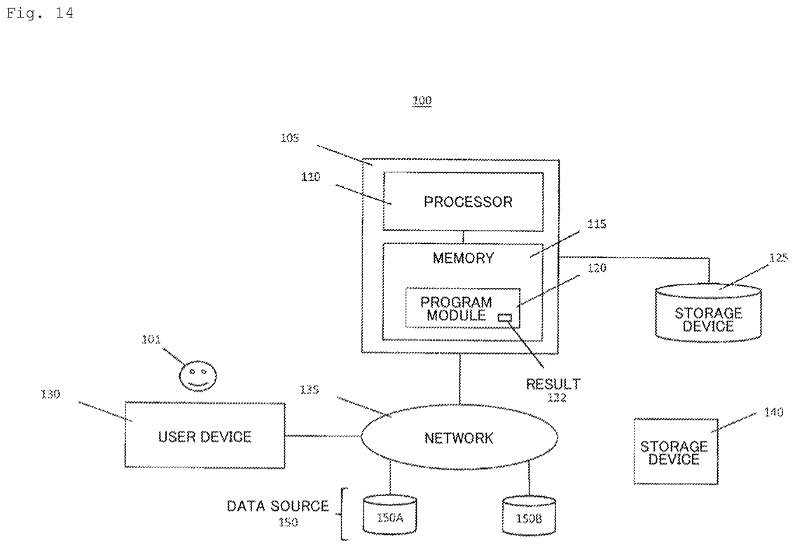

FIG. 14 shows a block diagram of a system 100 that represents the arithmetic apparatus 10. The system 100 includes a computer 105 connected to a network 135.

The network 135 is a data communication network. The network 135 may be a private network or a public network and can include any or all of (a) a personal area network that covers, for example, a certain room, (b) a local area network that covers, for example, a certain building, (c) a campus area network that covers, for example, a certain campus, (d) a metropolitan area network that covers, for example, a certain city, (e) a wide area network that covers, for example, a region that is connected by straddling the boundary of a city, a local area, or a nation, and (f) the Internet.

Communication is performed by an electronic signal and a light signal via the network 135.

The computer 105 includes a processor 110 and a memory 115 connected to the processor 110. The computer 105 is expressed as being a standalone device in the present specification but is not limited to the same. The computer 105 may be rather connected to other devices not shown in a distributed processing system.

The processor 110 is an electronic device constituted by a logic circuit that responds to a command and executes the command.

The memory 115 is a storage medium in which a computer program is encoded and which is tangible and readable by a physical computer. In this regard, the memory 115 stores data and a command, that is, a program code readable and executable by the processor 110 to control the operation of the processor 110. The memory 115 can be realized by a random access memory (RAM), a hard drive, a read-only memory (ROM) or a combination of these elements. One of the constituting elements of the memory 115 is a program module 120.

The program module 120 includes a command to control the processor 110 so that a process described in the present specification is executed. It is described in the present specification that operations are executed by the computer 105, a method, a process, or a lower process, but the operations are actually executed by the processor 110.

In the present specification, the term “module” indicates a functional operation that can be materialized as any of a standalone constituting element and an integrated configuration including a plurality of lower constituting elements. Accordingly, the program module 120 can be realized as a single module or a plurality of modules that operate in cooperation with each other. In addition, it is described in the present specification that the program module 120 is installed in the memory 115 and realized by software, but can be realized by hardware (for example, an electronic circuit), firmware, software, or a combination of these elements.

The program module 120 is shown as one that has been loaded into the memory 115 but may be configured to be positioned on a storage device 140 so that the program module 120 is to be loaded into the memory 115 later. The storage device 140 is a storage medium that stores the program module 120 and is readable by a physical computer. Examples of the storage device 140 can include a compact disk, a magnetic tape, a read-only memory, an optical storage medium, a memory unit constituted by a hard drive or a plurality of parallel hard drives, and a universal serial bus (USB) flash drive. Alternatively, the storage device 140 may be a random access memory or an electronic storage device of another type that is positioned in a distant storage system not shown and connected to the computer 105 via the network 135.

The system 100 further includes data sources 150A and 150B that are collectively called data sources 150 in the present specification and communicably connected to the network 135. Actually, the data sources 150 can include an arbitrary number of data sources, that is, one or more data sources. The data sources 150 include data not systemized and can include social media.

The system 100 further includes a user device 13 that is operated by a user 101 and connected to the computer 105 via the network 135. Examples of the user device 130 can include an input device such as a keyboard and a voice recognition sub-system that allows the user 101 to transmit the selection of information and a command to the processor 110. The user device 130 further includes an output device such as a display device, a printer, and a voice synthesis device. A cursor control unit such as a mouse, a track ball, and a touch sensitive type screen allows the user 101 to operate a cursor on a display device to transmit the further selection of information and a command to the processor 110.

The processor 110 outputs a result 122 of the execution of the program module 120 to the user device 130. Alternatively, the processor 110 can transmit the output to, for example, a storage device 125 such as a database and a memory or can transmit the same to a distant device not shown via the network 135.

For example, a program for performing the flowcharts of FIGS. 11 and 12 may be set as the program module 120. The system 100 can be caused to operate a an arithmetic processing unit D.

The term “include” or “including” indicates the existence of a feature, a complete body, a step, or a constituting element described herein, but it should be interpreted that one or more other features, complete bodies, steps, constituting elements, or groups or these elements are not excluded. The terms “a” and “an” are indefinite articles, and an embodiment having a plurality of constituting elements should not be excluded.

### OTHER EMBODIMENTS

Note that the present invention is not limited to the above embodiments but can be modified in various ways and carried out without departing from the gist thereof. In short, the present invention is not directly limited to the above embodiments, but its constituting elements can be modified and materialized without departing from the gist at an execution stage.

Further, various inventions can be formed in such a manner that a plurality of constituting elements disclosed in the above embodiments are appropriately combined together. For example, some of all the constituting elements shown in the embodiments may be deleted. In addition, constituting elements over different embodiments may be appropriately combined together.

[Appendix 1]

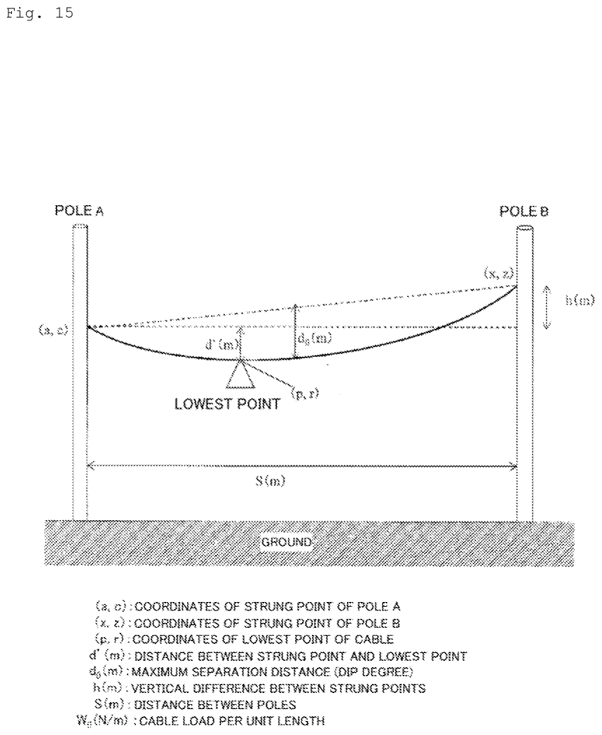

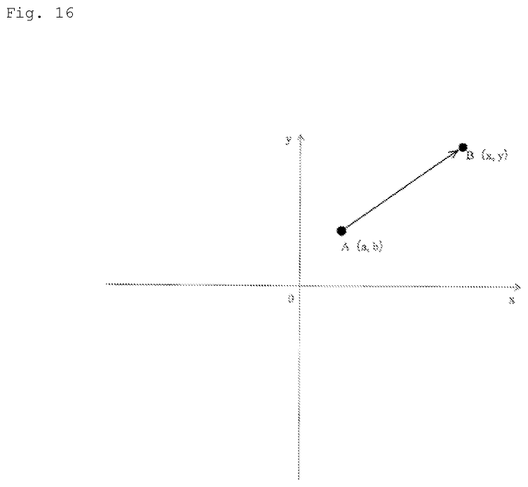

FIGS. 15 and 16 are views for explaining the derivation of Math. C1.

Since a cable between poles is expressed by a catenary curve, the following formula (catenary formula) is established.

$$\begin{matrix}[ Math . A1 - 1 ] & \\ ∴ y = ε cosh \frac{x}{ε} - ε \\ where ε = \frac{T 0}{W 0} . & ( A1 - 1 )\end{matrix}$$

Further, when the third or lower terms of the series expansion portion of coshx are ignored,

$$\begin{matrix}[ Math . A1 - 2 ] & \\ cosh x \approx 1 + \frac{1}{2 !} {x}^{2} & ( A1 - 2 )\end{matrix}$$

can be approximated. Therefore, the following formula is established with respect to the above catenary formula.

$$\begin{matrix}[ Math . A1 - 3 ] & \\ y = ε cosh \frac{x}{ε} - ε \approx ε \{ 1 + \frac{1}{2 !} {( \frac{x}{ε} )}^{2} \} - ε \\ ∴ y = \frac{{x}^{2}}{2 ε} & ( A1 - 3 )\end{matrix}$$

The coordinates of the strung points of a cable between poles A and B and the coordinates of the lowest point of the cable are defined as shown in FIG. 15. At this time, two points (a, c) and (x, z) are points on a catenary curve. Therefore, the following formula is established.

$$[ Math . A 1 - 4 ]$$

$$c = \frac{{a}^{2}}{2 ε} \qquad ( A 1 - 4 )$$

$$z = \frac{{x}^{2}}{2 ε}$$

Here, when it is assumed that h=z−c and s=x−a, the following formula is established as the equation of a line passing through the two points.

$$[ Math . A 1 - 5 ]$$

$$Y = \frac{z - c}{x - a} ( X - x ) + z = \frac{h}{s} ( X - x ) + \frac{{x}^{2}}{2 ε} \qquad ( A 1 - 5 )$$

Further, f(X) is set as shown in the following formula.

$$[ Math . A 1 - 6 ]$$

$$f ( X ) = \frac{h}{s} ( X - x ) + \frac{{x}^{2}}{2 ε} - \frac{{X}^{2}}{2 ε} - 1 \frac{1}{2 ε} {( X - \frac{ε h}{S} )}^{2} + \frac{ε {h}^{2}}{2 {s}^{2}} - \frac{h}{s} x + \frac{{x}^{2}}{2 ε} \qquad ( A1 - 6 )$$

The formula is obtained by subtracting the catenary curve from the equation of the line, and the maximum value of f(X) becomes a dip degree d₀ (m). On the other hand, the following formula is established from the inclination of the line.

$$[ Math . A 1 - 7 ]$$

$$\frac{h}{S} = \frac{z - c}{x - a} = \frac{1}{a - x} ( \frac{{a}^{2}}{2 ε} - \frac{{x}^{2}}{2 ε} ) = \frac{x + a}{2 ε} = \frac{2 x - S}{2 ε} \qquad ( A1 - 7 )$$

$$( ∵ c = \frac{{a}^{2}}{2 ε} , z = \frac{{x}^{2}}{2 ε} )$$

$$[ Math . A 1 - 8 ]$$

$$∵ x = \frac{1}{2} s + \frac{ε h}{S} ) \qquad ( A1 - 8 )$$

When X=sh/S, f(X) becomes maximum. At this time, the following formula is established.

$$[ Math . A 1 - 9 ]$$

$$\begin{matrix}{d}_{0} = f ( \frac{ε h}{S} ) \\ = \begin{matrix}\frac{h}{S} ( \frac{ε h}{S} - x ) + \frac{{x}^{2}}{2 ε} - \frac{ε {h}^{2}}{2 {s}^{2}} & ( ∵ Formula A 1 - 6 )\end{matrix} \\ = \frac{h}{S} ( \frac{ε h}{S} - \frac{1}{2} s - \frac{ε h}{S} ) + h + c - \frac{ε {h}^{2}}{2 {s}^{2}} \\ ( ∵ Formula A 1 - 8 , h = z - c ) \\ = \frac{h}{2} + c - \frac{ε {h}^{2}}{2 {S}^{2}} \\ = \begin{matrix}\frac{h}{2} + c - \frac{{T}_{0} {h}^{2}}{2 {W}_{0} {S}^{2}} & ( ∵ ε = \frac{{T}_{0}}{{W}_{0}} )\end{matrix}\end{matrix} \qquad ( A1 - 9 )$$

When the tension formula of Math. C2 is substituted into Math. A9, the following formula is obtained.

$$[ Math . A 1 - 10 ]$$

$$( A 1 - 10 )$$

$${d}_{0}^{2} - ( \frac{h}{2} + c ) {d}_{0} + \frac{{h}^{2}}{1 \text{?}} = 0$$

$$\text{?} \text{indicates text missing or illegible when filed}$$

According to the formula of the solution of a quadratic equation, d₀ is expressed as follows.

$$[ Math . A 1 - 11 ]$$

$${d}_{0} = \frac{\frac{h}{2} + c + \sqrt{{c}^{2} + hc}}{2} \qquad ( A1 - 11 )$$

The calculation described above is performed with the assumption that the coordinates of the lowest point pass through the origin (0, 0). Here, when the coordinates of the lowest point pass through (p, r) without passing through the origin, Math. All is modified as follows.

$$[ Math . A 1 - 12 ]$$

$${d}_{0} = \frac{\frac{z - c}{2} + ( c - r ) + \sqrt{{( c - r )}^{2} + ( c - r ) ( z - c )}}{2} \qquad ( A1 - 12 )$$

$$( ∵ c \to c - r , h = z - c )$$

In the manner described above, d₀ of Math. C1 is derived. The same value is obtained in a three-dimensional coordinate system as well.

Further, since the square root of the sum of the squares of distances of respective axes is only required to be taken to calculate a distance between A and B in the two-dimensional coordinates of FIG. 16, √((x−a)²+(y−b)²) is calculated. Accordingly, the S (m) between the poles is calculated as follows when the formula for calculating a distance between two Points is used.

[Math. A1-13]

S=\sqrt{(x−a)²+(y−b)²} (A1-13)

In the manner described above, S of Math. C1 is derived.

[Appendix 2]

When wind blows, a wind pressure load Pc (kN) generated in a cable is calculated by the following formula.

Pc=K″·Σd·S [Math. A2-1]

Here, K″ (kN/m²) represents a coefficient (first type: 0.98, second type: 0.49) according to a wind pressure load type. Σd (m) represents the sum of the outer diameters of various cables (the sum of the outer diameters of cables+the sum of the outer diameters of additional cables). S (m) represents an average pole interval.

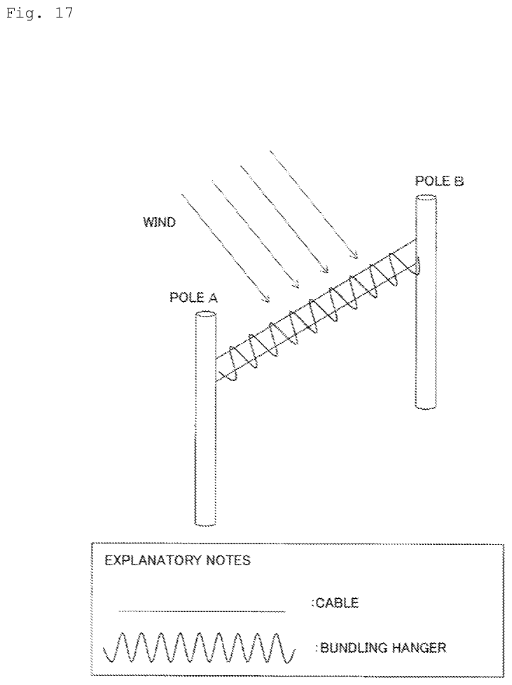

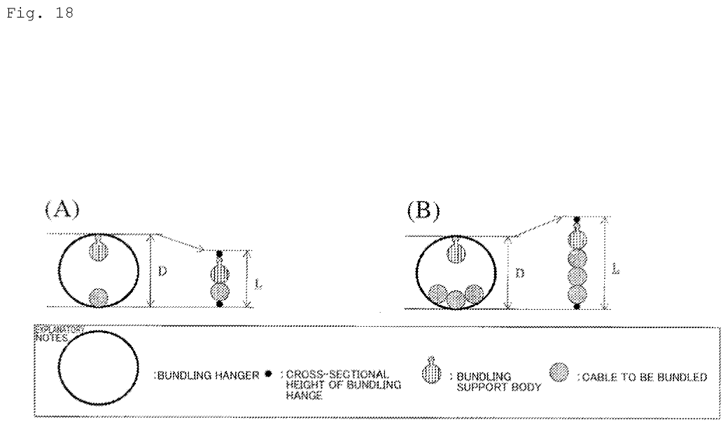

For example, in the case of a bundling mode as shown in FIG. 17, a bundling hanger and cables are subjected to wind pressure. Here, it is assumed that the outer diameter of the bundling hanger is represented as D (m) and the total of the outer diameters of cables inside the bundling hanger and the cross-sectional height of the bundling hanger is represented as L (m) as shown in FIG. 18, the sum of the outer diameters is classified into two according to the total of the outer diameters of the cables inside the bundling hanger.
(A) When the sum of the outer diameters of the cables is less than or equal to the outer diameter of the bundling hanger (D≥L), the sum of the outer diameters becomes L (m).
(B) When the sum of the outer diameters of the cables is greater than the outer diameter of the bundling hanger (D>L), the sum of the outer diameters becomes D (m).

[Appendix 3]

The derivation of a formula (Math. C3) for calculating a dip degree will be described.

The relational expression between a temperature, a load, and a dip degree is expressed by the following formula. The following formula is a relational expression established when a surrounding temperature and a perpendicular load per unit length are changed with respect to a hung cable, and is a general formula applicable to both a flat ground and a sloping ground.

$$[ Math . A 3 - 1 ]$$

$${d}_{1}^{3} + ( \frac{3}{\text{?}} {S}^{2} \{ \frac{{T}_{0}}{EA} - α ( {θ}_{1} - {θ}_{0} ) \} - {d}_{0}^{2} ) {d}_{1} = \frac{3 {W}_{1} {S}^{4}}{64 EA} \qquad ( A3 - 1 )$$

$$[ Math . A 3 - 2 ]$$

$$∵ {d}_{0} = \frac{W \text{?} {S}^{2}}{\text{?}} , {d}_{1} = \frac{W \text{?} {S}^{2}}{\text{?}} \qquad ( A3 - 2 )$$

$$\text{?} \text{indicates text missing or illegible when filed}$$

Note that
S (i) represents an interval, between poles,
L (m) represents the length of a cable in a strung state,
d₀ (m) represents a dip degree at a temperature of θ₀° C. and at
a load (kN/m) of a cable per one meter,
T₀ (kN) represents tension at a temperature of θ₀° C. and at a load (kN/m) of a cable per one meter,
d₁ (m) represents a dip degree at a temperature of θ₁° C. and at a load (kN/m) of a cable per one meter,
T₁ (kN/m) represents tension at a temperature of θ₁° C. and at a load (kN/m) of a cable per one meter,
α (1/*C) represents the linear expansion coefficient of a cable per 1° C. and is 1.111×10⁻⁵,
EA (kN) represents the elastic coefficient of a suspension line or a column line,
H (m) represents a vertical interval in one span,
θ₀ and θ₁ (° C.) represents a temperature,
W₀ and W₁ (kg/m) represents a load including an own weight and wind pressure of a cable such as a cable and a suspension line per one meter,

When Math. A3-2 is substituted into Math. A3-1 and organized, Math. C3 is obtained.

[Appendix 4]

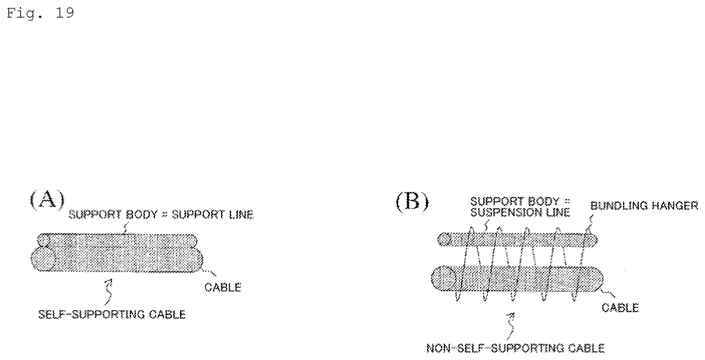

FIG. 19 is a view for explaining the mode of a cable.

A support body represents a suspension line or a support line. The support body bears the tension of a communication cable and is classified into a suspension line or a support line depending on the shape of the communication cable. The communication cable includes a “self-supporting cable” and a “non-self-supporting cable”. FIG. 19(A) shows the case of a self-supporting cable, and a support line serving as a support body bears the tension of a cable and a line. FIG. 19(B) shows the case of a non-self-supporting cable, and a suspension line serving as a support body bears the tension of the non-self-supporting cable according to a bundling method or the like.

### REFERENCE SIGNS LIST

10 Arithmetic apparatus
11 Input unit
12 Coordinate acquisition unit
13 Arithmetic unit.

1. An arithmetic apparatus comprising:
an input unit to which point cloud data of outdoor structures to be managed and a cable hung on the outdoor structures is input;
a coordinate acquisition unit that acquires coordinate (p, q, r) of a lowest point of the cable and coordinates (a, b, c) and (x, y, z) of strung points at which the cable is hung on the two outdoor structures from the point cloud data; and
an arithmetic unit that
calculates a distance S (m) between the outdoor structures and a dip degree d₀ (m) of the cable according to Math. C1,
substitutes a load W₀ (N/m) of the cable per unit length obtained from a database, the distance S, and the dip degree do into Math. C2 to calculate tension T₀ (N) of the cable applied to the outdoor structures,
multiplies the tension T₀ (N) by heights Hᵢ (m) of the strung points to calculate moment (N·m) at the strung points, and
divides the moment by one arbitrary height H (m) of the outdoor structures to calculate a load T′ (N).
$$[ Math . C 1 ]$$
$$S = \sqrt{{( x - a )}^{2} + {( y + b )}^{2}} \qquad ( C 1 )$$
$${d}_{0} = \frac{\frac{z - c}{2} + ( c - r ) + \sqrt{{( c - r )}^{2} + ( c - r ) ( z - c )}}{2}$$
$$[ Math . C 2 ]$$
$${T}_{0} = \frac{{W}_{0} {S}^{2}}{8 {d}_{0}} \qquad ( C 2 )$$

2. The arithmetic apparatus according to claim 1, wherein,
when the cable is constituted by one or a plurality of cables, a support body hung between the strung points of the outdoor structures, and a bundling hanger with which the cables are hung on the support body and when wind blows during acquisition of the point cloud data,
the arithmetic unit regards tension T₁ (N) calculated according to Math. C3 as the tension T₀ (N).
$$[ Math . C 3 ]$$
$${T}_{1}^{3} + EA \{ ( α ( {θ}_{1} - {θ}_{0} ) + \frac{1}{24} {( \frac{{W}_{0} S}{{T}_{0}} )}^{2} - \frac{{T}_{0}}{EA} \} {T}_{1}^{2} - \frac{1}{24} {EA ( {W}_{1} S )}^{2} = 0 \qquad ( C3 )$$
where
θ₀ (° C.) represents a temperature when no wind blows, θ₁ (° C.) represents a temperature when wind blows, E (N/m²) represents a Young's modulus of the support body, A (m²) represents a cross-sectional area of the support body, α (1/° C.) represents a linear expansion coefficient of the support body, W₁ (N/m)=√(W₀²+W_{c}²) represents a cable load per unit length when wind blows, and W_{c} (N/m) represents a wind pressure load per unit length generated in the cable due to wind. The wind pressure load W_{c} (N/m) is calculated according to Math. C4 using a coefficient K (N/m²) according to a wind pressure load type, an outer diameter D (m) of the bundling hanger, and a total L (m) of the outer diameters of the cables supported by the bundling hanger and a cross-sectional height of the bundling hanger.
$$[ Math . C 4 ]$$
$$\{ \begin{matrix}\begin{matrix}When a sum of the outer diameters of the cables is less than \\ or equal to the outer diameter D ( m ) of the bundling hanger\end{matrix} \\ Wc = K \times L \\ \begin{matrix}When a sum of the outer diameters of the cables is greater \\ than the outer diameter D ( m ) of the bundling hanger\end{matrix} \\ Wc = K \times D\end{matrix}$$

3. The arithmetic apparatus according to claim 1, wherein,
when a plurality of the cables exist,
the arithmetic unit
calculates the moment (N·m) for each of the cables,
vector-adds the moment (N·m) for each of the cables to calculate combined moment, and
divides the combined moment by the arbitrary height H (m) to calculate a combined load T′ (N).

4. The arithmetic apparatus according to claim 1, wherein,
when the outdoor structures are accompanied with an accessory having a weight of Z (N),
the arithmetic unit
multiplies the weight Z (N) by a horizontal distance L (m) between a strung point at which the accessory is attached to the outdoor structure and a center of gravity of the accessory to calculate moment (N·m) at the strung point of the accessory,
vector-adds the moment (N·m) of the cable and the accessory to calculate combined moment, and
divides the combined moment by the arbitrary height H (m) to calculate a combined load T′ (N).

5. A facility management method comprising:
acquiring point cloud data of outdoor structures to be managed and a cable hung on the outdoor structures;
acquiring coordinate (p, q, r) of a lowest point of the cable and coordinates (a, b, c) and (x, y, z) of strung points at which the cable is hung on the two outdoor structures from the point cloud data;
calculating a distance S (m) between the outdoor structures and a dip degree d₀ (m) of the cable according to Math. C1;
substituting a load W₀ (N/m) of the cable per unit length obtained from a database, the distance S, and the dip degree d₀ into Math. C2 to calculate tension T₀ (N) of the cable applied to the outdoor structures;
multiplying the tension T₀ (N) by heights Hᵢ (m) of the strung points to calculate moment (N·m) at the strung points; and
dividing the moment by one arbitrary height H (m) of the outdoor structures to calculate a load T′ (N).
$$[ Math . C 1 ]$$
$$S = \sqrt{{( x - a )}^{2} + {( y + b )}^{2}} \qquad ( C 1 )$$
$${d}_{0} = \frac{\frac{z - c}{2} + ( c - r ) + \sqrt{{( c - r )}^{2} + ( c - r ) ( z - c )}}{2}$$
$$[ Math . C 2 ]$$
$${T}_{0} = \frac{{W}_{0} {S}^{2}}{8 {d}_{0}} \qquad ( C 2 )$$

6. The facility management method according to claim 5, wherein
the cable is constituted by one or a plurality of cables, a support body hung on the strung points of the outdoor structures, and a bundling hanger with which the cables are hung on the support body, and
tension T₁ (N) calculated from Math. C3 is regarded as the tension T₀ (N) when wind blows during acquisition of the point cloud data.
$$[ Math . C 3 ]$$
$${T}_{1}^{3} + EA \{ ( α ( {θ}_{1} - {θ}_{0} ) + \frac{1}{24} {( \frac{{W}_{0} S}{{T}_{0}} )}^{2} - \frac{{T}_{0}}{EA} \} {T}_{1}^{2} - \frac{1}{24} {EA ( {W}_{1} S )}^{2} = 0 \qquad ( C3 )$$
where
θ₀ (° C.) represents a temperature when no wind blows, θ₁ (° C.) represents a temperature when wind blows, E (N/m²) represents a Young's modulus of the support body, A (m²) represents a cross-sectional area of the support body, α (1/° C.) represents a linear expansion coefficient of the support body, W₁ (N/m)=√(W₀²+W_{c}²) represents a cable load per unit length when wind blows, and W_{c} (N/m) represents a wind pressure load per unit length generated in the cable due to wind. The wind pressure load W_{c} (N/m) is calculated according to Formula C4 using a coefficient K (N/m²) according to a wind pressure load type, an outer diameter D (m) of the bundling hanger, and a total L (m) of the outer diameters of the cables supported by the bundling hanger and a cross-sectional height of the bundling hanger.
$$[ Math . C 4 ]$$
$$\{ \begin{matrix}\begin{matrix}When a sum of the outer diameters of the cables is less than \\ or equal to the outer diameter D ( m ) of the bundling hanger\end{matrix} \\ Wc = K \times L \\ \begin{matrix}When a sum of the outer diameters of the cables is greater \\ than the outer diameter D ( m ) of the bundling hanger\end{matrix} \\ Wc = K \times D\end{matrix}$$

7. The facility management method according to claim 5, wherein,
when the outdoor structures are accompanied with an accessory having a weight of Z (N),
multiplying the weight Z (N) by a horizontal distance L (m) between a strung point at which the accessory is attached to the outdoor structure and a center of gravity of the accessory to calculate moment (N·m) at the strung point of the accessory,
vector-adding the moment (N·m) of the cable and the accessory to calculate combined moment, and
dividing the combined moment by the arbitrary height H (m) to calculate a combined load T′ (N) are performed.

8. A non-transitory computer-readable medium having computer-executable instructions that, upon execution of the instructions by a processor of a computer, cause the computer to function as the arithmetic apparatus according to claim 1.
